(19) United States
(12) Patent Application Publication
(10) Pub. No.: US 2006/0291605 A1
(43) Pub. Date: Dec. 28, 2006

(54) Nuclear waste disposal through proton decay

(76) Inventor: A. Christian Tahan, Cambridge, MA (US)

Correspondence Address: A. Christian Tahan, PO Box 391987, Cambridge, MA, 02139, US

(21) Appl. No.: 11/475,489

(22) Filed: Jun. 26, 2006

Related U.S. Application Data
(63) Continuation-in-part of application No. 10/537,532, filed on Jun. 3, 2005.
(60) Provisional application No. 60/693,872, filed on Jun. 24, 2005.

(51) Int. Cl. H05H 1/22

(52) U.S. Cl. 376/100

(57) ABSTRACT

Proton decay can be used to process waste produced from nuclear power plants by using the method of proton decay to convert the waste to other elements. Decay is a transformation to a neutron accompanied by a positron and electron neutrino in that the proton is not breaking apart as in fission. The method can allow for the processing of waste to non-radioactive elements. Proton decay could allow the waste to be reused in that the method provides the opportunity to recycle the waste as for power production, and the process of transforming the waste can be used as a power source for the production of electricity. Converted waste can be used for other applications such as medical isotopes in addition to reuse in nuclear power plants.

Continuation in part of U.S. patent application Ser. No. 10/537,532

### FIELD OF THE INVENTION

This invention relates to the use of proton decay to eliminate spent fuel or waste generally from the process of power production through nuclear power plants, including waste generated in the process of obtaining elements, as in mining or processing, to be used in the power plants.

### BACKGROUND OF THE INVENTION

In creating industries, disposal of related waste is not typically a main consideration until after build-up has occurred. Nuclear waste is an example in that 50,000 tons of high-level nuclear waste is spread across the US (Vartabedian, R., “Nuclear industry poised for comeback,” The Nation, Los Angeles Times, Jun. 22, 2005), and the waste is not wanted particularly to be transported through communities. The large amount of nuclear waste exists since no spent fuel has been reprocessed in the US. (Source: US Department of Energy) Mining of materials for the plants creates additional waste that also has been stored. Waste is elements that need proper processing or disposal.

A new era of nuclear power is being promoted by the President George W. Bush administration and plans for new nuclear power reactors are being made. The proposed resolution to the growing problem of nuclear waste is continued storage and the creation of new storage facilities as at Yucca Mountain, which may not be approved as a geological repository for spent nuclear fuel due primarily to citizen concerns. Studies related to a permanent storage facility started in 1983, and through 2004 more than US$10 billion has been spent to reach the point of having selected Yucca Mountain as a potential site. (Settle, F., “Nuclear Chemistry: Nuclear and Chemical Wastes,” chemcases.com)

Alternatives to storage have been considered. For example, fission involving accelerators or other reactors and spallation to produce required neutrons for the fission process to convert the waste elements to other elements has been considered. But the proposals would involve the need of separating elements in the waste, would be energy consumptive, costly, fission would create additional waste that would require handling and storage, and the processing of the waste would be time consuming in that the fission idea would be typically a multi-step resolution. Other ideas for disposal have had similar problems with primarily a substantial amount of energy having to be delivered to the nucleus of a long-lived radionuclide to induce a nuclear reaction as fission. Essentially, apart from storage no economical solution has existed for the processing of waste before this application related to processing through proton decay.

### SUMMARY OF THE INVENTION

Proton decay was achieved by placing a proton in a sufficiently strong magnetic field and subjecting the nucleus to low frequency electromagnetic signals from an antenna adjacent the nucleus as described in U.S. patent application Ser. No. 10/537,532. Accordingly, the proton absorbs quanta to transform to a neutron that is accompanied by a positron and electron neutrino: p→n, e⁺, νₑ. The equation for proton decay is a transformation to the neutron in that the proton is not breaking apart or undergoing fission.

The decay of the proton to the state of the neutron, positron and electron neutrino has been documented in U.S. patent application Ser. No. 10/537,532 as a means for mass and heat energy releases. For example, availability of the positron allows for particle-antiparticle annihilation with electrons, and presence of the electron neutrino also allows for particle-antiparticle annihilation. By that, the process of waste disposal through proton decay could be a power means to produce electricity. Creation of neutrons allows for the eventual progression to gravity (gravitons) and anti-gravity (graviphotons) as described rudimentarily in Ser. No. 10/537,532 that could help in the disposal and conversion of the waste. The focus of this application regarding the emergence of the neutron from the proton is that the simple means for production of the neutron through proton decay allows for the creation of elements or the transformation of elements in nuclear waste to new elements particularly through fusion inexpensively and rapidly. Accordingly, waste disposal through proton decay is a means for mass and heat energy generation in that the method and apparatus for proton decay incorporating the nuclear waste releases energy, heat and mass as in the form of elements. As stated, the process of proton decay allows for fusion that is a primary method for the creation of elements, but the creation of elements is not limited to fusion in that another method associated with proton decay can be used. Proton decay is an inexpensive and fast method for producing neutrons that is superior to other methods.

Proton decay for waste processing has numerous advantages. Nuclear waste disposal through proton decay does not create additional waste but converts waste to new elements in that the exchange is one to one: unwanted isotope to element that can be reused or for another purpose. Experimentation led to the conclusion that four to six neutrons added to nuclei per hour in that specific elements can be created by gauging the amount of time the elements are in the apparatus. The process is inexpensive, safe being a controlled process that can be stopped simply by turning off the source of quanta, and does not require high energy input in that proton decay has been achieved with use of an oscillator circuit that can be designed to run on a 9V battery. Accordingly, a substantial amount of energy need not be delivered to the nucleus for proton decay, specifically for fusion through proton decay. Radiation released with the method and apparatus for proton decay is in small amounts, unless scaled for simultaneous large scale processing, from the fusion process so that the machine is relatively safe.

Nuclear waste disposal through proton decay can produce elements that have been difficult and expensive to produce previously, including potentially elements not on the periodic table, so that new nuclear fuel cycles involving the elements (as with produced Einsteinium) can be used and could be more productive. Additionally, the process is not time consuming, is portable, and division of waste is not necessarily needed in that all the waste can be placed in the machine for all the elements to be transformed. For example, the ceramic pellets in rods used in fission reactors containing waste can be placed in the apparatus for waste conversion to different elements for proper storage or reuse. The elements in the pellets do not need to be separated prior to inclusion in the apparatus for transformation. The proton decay method eliminates the need for reprocessing of nuclear waste that is proliferating and a highly polluting process. The sulfuric acid used as the proton source for the apparatus can be substituted with a different proton source.

[image]

The creation of new elements from a different element can be seen in the Germanium (Ge) detector (Canberra GR4021) graph above that is an energy peak that corresponds to Pt-99, which does not have a parent nuclide. By that, the element had to have been created. The element was created from Tungsten (W) that had been placed in the apparatus. Detection of Pt-199 confirmed that the fusion process involved free neutrons entering the nucleus, particularly when considering the 121 total neutrons for the isotope. By that, no free neutrons existed prior to the experiment or the turning on of the apparatus in that the neutrons that had entered W nuclei could only have been from proton transformation: p→n, e⁺,νₑ. The radiation from the sample collection that suggested presence of Pt-199 is intriguing since the Ge detector when run alone nearly daily for calibration has never detected radiation from sources other than naturally-occurring radioisotopes (typical background). In other words, the energy peak for the above graph was from a sample placed on the detector that had been taken from the apparatus.

### BRIEF DESCRIPTION OF THE DRAWINGS

These and other features of the subject invention will be better understood in connection with the Detailed Description, in conjunction with the Drawings, of which:

FIG. 1 is a diagrammatic illustration of the subject process in which waste from a power plant is processed in the apparatus to be stored, used for a different means as in medicine, or to be reused in the power plant;

FIG. 2 is the output graph of a Differential Thermal Analysis that shows melting point evidence of Radium, Uranium, and Einsteinium.

### DETAILED DESCRIPTION

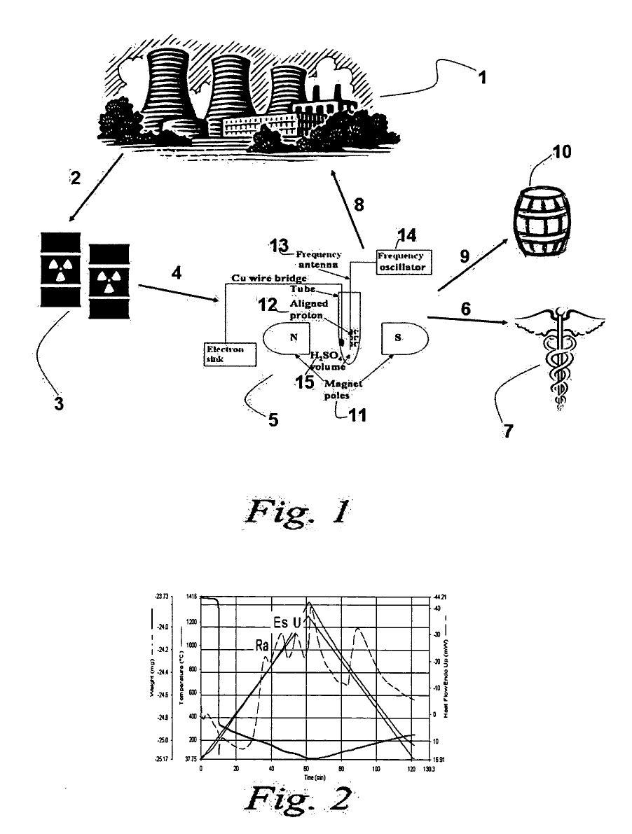

Referring now to FIG. 1, the schematic illustrates the simplicity of nuclear waste disposal through proton decay in that the waste 3 removed from 2 the power plant 1 is incorporated 4 with the inexpensive method and apparatus for proton decay 5 to transform the waste 6, 8, 9 to usable products as elements to be reused in a power plant 1, for storage or disposal 10 due to a converted safer nature, or for the products to be used for other purposes as for medical isotopes 7 or for other uses. The primary components of the apparatus are the magnetic field 11, protons 12, and a proximate low frequency antenna 13. A 22-guage Copper wire was used in trials as the antenna leading from a breadboard that was connected to a function oscillator 14 or generator to produce the frequency. The protons 12 were obtained primarily due to electrolysis from the sulfuric acid (H₂SO₄) 15, which was inexpensive, easily available and can be recycled for additional use. A different proton source can be incorporated for productivity. The machine is portable, can be conveniently stored, and can be expanded for the incorporation of a larger amount of waste.

A proton held aligned in the magnetic field 11 during absorptions of specific frequency quanta from the proximate antenna 13 will decay to a neutron. Element waste placed in the machine can be reprocessed with use of proton decay since the neutron can enter in a nucleus leading to Beta decay and production of an atom of higher atomic number. Proton decay allows for the generation of new elements since neutrons being without charge do not have an electromagnetic repulsive barrier to overcome. Specifically, elements on the periodic table are differentiated by proton number. A new element is created when a proton is added to the nucleus. Accordingly, proton decay allows for a proton to add to a nucleus by initially being a neutron then undergoing Beta decay.

As shown in FIG. 2, Differential Thermal Analysis (DTA) with alumina powder as the reference was used to examine a collection from a trial. DTA is a simple method for determining compositions by recording melting points (mp). Since elements have distinct melting points, more than one element in a sample could be observed with individual and relative curves. The maximum temperature for the DTA machine (Perkin Elmer Pyris Diamond TG/DTA) was approximately 1200° C. The machine was run at a temperature increase rate of 20° C./min.

Einsteinium (Es, melting point=860° C.) is in FIG. 2 with Radium (Ra, melting point=700° C.) and Uranium (U, melting point=1132° C.). The peaks indicate that a range of elements can be produced, to be separated as with a filtration technique as involving a resin or centrifugation, with the proton decay process. Or the method can be used specifically for the production of a particular element with consideration that production is scalable. Accordingly, nuclear waste need not be divided or separated prior to incorporation in the proton decay machine. The elements were created through proton decay (transformation) by neutrons adding to nuclei, e.g. Es emerged by neutrons adding to a U nucleus. The U was produced from W in that due to protons decaying, 54 neutrons added to a W nucleus with eighteen protons emerging from Beta decay. The result demonstrated apart from proton decay to the neutron having occurred that elements for fuel could be produced in the laboratory, reducing the need for mining.

What is claimed is:

1. A method for the release of energy, comprising the steps of:
placing nuclei in a magnetic field at room temperature; and,
subjecting the nuclei to a low frequency electromagnetic signal from an antenna adjacent the nuclei.

2. The method of claim 1, wherein the low frequency is 0.5-3 Hz.

3. The method of claim 1, wherein the low frequency is a harmonic of 0.5 Hz.

4. The method of claim 1, wherein the release of energy is from the creation of gravitons and associated particles from the decay of protons.

5. The method of claim 1, wherein the release of energy is from particle-antiparticle annihilation.

6. The method of claim 1 for power generation in power plants.

7. The method of claim 1 as a portable source for the production of neutrons from proton decays.

8. The method of claim 1 for waste processing comprising the steps of:
placing elements considered waste in a magnetic field at room temperature; and, subjecting the nuclei to a low frequency electromagnetic signal from an antenna adjacent the nuclei.

9. The method of claim 8, wherein the processing is from a fusion process involving subjecting a proton and other element to an electromagnetic signal in the presence of the magnetic field to produce a third element.

10. The method of claim 9, wherein the other element is waste from a nuclear reactor or power plant.

11. The method of claim 9 for producing medical isotopes.

12. Apparatus for generating energy comprising:
a magnetic field;
a proton in said magnetic field;
an antenna adjacent said proton;
an electromagnetic signal source coupled to said antenna for producing harmonics of 0.5 Hz.

13. The apparatus of claim 12, wherein the low frequency is 0.5-3 Hz.

14. The apparatus of claim 12, wherein said proton is created from a volume of H₂SO₄, a wire having an end in said H₂SO₄, and an electron sink coupled to the other end of said wire.

15. The apparatus of claim 12 for waste management including the disposal of nuclear waste, as from nuclear power plants or weapon stockpiles, by converting the elements that is considered waste to other elements including non-radioactive elements.

16. The apparatus of claim 12 to produce elements and use of the generated heat in the process for the production of electricity.

17. The apparatus of claim 12 to create elements or molecules as fuel generally, including hydrogen fuels.

18. The apparatus of claim 12 to recycle nuclear waste as Uranium by removing the waste from the rods used in a power plant, putting the elements in the apparatus, exposing the waste elements to the procedure of proton transformation (decay) for a specific time, keeping elements in the procedure for an amount of time corresponding to the element desired, removing desired elements.

19. The apparatus of claim 12 to produce radiation for therapy.
